(19) United States
(12) Patent Application Publication
(10) Pub. No.: US 2004/0266921 A1
(43) Pub. Date: Dec. 30, 2004

(54) Use of (hydroxyalkyl)urea and/or (hydroxyalkyl)amide for maintaining hydration of aqueous polymer compositions

(76) Inventors: Klein A. Rodrigues, Signal Mountain, TN (US); Yves De Smet, Denderhoutem (BE); Stacey L. Elliott, Philadelphia, PA (US)

Correspondence Address: NATIONAL STARCH AND CHEMICAL COMPANY, P.O. BOX 6500, BRIDGEWATER, NJ, 08807-3300, US

(21) Appl. No.: 10/606,420

(22) Filed: Jun. 26, 2003

(51) Int. Cl. C08L 1/00

(52) U.S. Cl. 524/211; 524/236

(57) ABSTRACT

The present invention relates to the use of (hydroxyalkyl)urea and (hydroxyalkyl)amide in aqueous-based polymer compositions to maintain hydration of said composition. Maintenance of hydration improves properties such as freeze/thaw stability, stability of the polymer composition, retardation of evaporation from the composition, and retardation of evaporation from wetted articles containing said polymer composition.

### FIELD OF THE INVENTION

The present invention relates to the use of (hydroxyalkyl)urea and (hydroxyalkyl)amide in aqueous-based polymer compositions to maintain hydration of said composition. Maintenance of hydration improves properties such as freeze/thaw stability, stability of the polymer composition, retardation of evaporation from the composition, and retardation of evaporation from wetted articles containing said polymer composition.

### BACKGROUND OF THE INVENTION

Aqueous polymer compositions are complex systems that can become destabilized by the loss of hydration. The loss of hydration can be in the form of water loss from the composition into the environment, leading to chemical and physical changes in the composition such as increased viscosity, the onset of coalescence of particles, the beginning of cross-linking reactions, or the drying of pre-wetted articles. The loss of hydration can also be a localized phenomena such as the loss of hydration of stable polymer particles during freezing—leading to coalescence and agglomeration. These changes result in a composition that no longer functions as intended, and in many cases the composition is irreversibly damaged and rendered useless.

U.S. Pat. No. 5,482,640 describes the use of small monohydric alcohols to stabilize aqueous dispersions against the harmful effects of freeze/thaw cycles. The reference describes a mechanism for dispersion instability relating to the freezing process withdrawing the water of hydration from the dispersed particles, causing them to lose their mutual repulsion and coalesce.

Hydroxyalkyl urea compounds have been used in formulations applied to substrates to act as moisturizers and moisture retention aids.

U.S. Pat. No. 6,500,212 describes the use of hydroxyalkyl ureas as a treatment to impart wrinkle reduction and improve feel in materials. The treatment increases the moisture adsorbancy and retention in fabrics.

DE 27 03 185 describes cosmetic agents for skin that contain hydroxyalkyl-substituted ureas. Said hydroxyalkyl-substituted ureas act as moisturizers for the skin.

There is a need for a compound that can be added to aqueous polymer formulations to maintain hydration of the composition without adversely effecting the end-use properties of the polymer composition.

Surprisingly, it has been found that the addition of small amounts of a hydroxy alkyl urea or hydroxy alkyl amide compound to an aqueous polymer composition can help maintain hydration of the composition, leading to improved properties such as freeze/thaw stability. There are several advantages of using the hydroxy alkyl urea or hydroxyalkyl amides of the present invention over other methods currently practiced. The hydroxy alkyl urea or hydroxyalkyl amides are naturally derived, making them environmentally friendly and potentially biodegradable. The hydroxy alkyl urea or hydroxyalkyl amides are non-volatile, and can be used to replace alcohols, glycols and other substances currently used, thereby reducing the VOC content of a formulation. Additionally, films formed from aqueous polymer compositions stabilized with hydroxy alkyl urea or hydroxyalkyl amide are not tacky or sticky, as opposed to films formed from glycol-stabilized emulsions.

### SUMMARY OF THE INVENTION

The present invention relates to a method for maintaining hydration of an aqueous-based polymer composition involving admixing an aqueous-based polymer composition and from 0.01 to 50 percent by weight of one or more hydroxy compounds selected from the group consisting of hydroxyalkyl ureas, hydroxyalkyl amides, and mixtures thereof.

The present invention also relates a method of maintaining hydration of a substrate comprising:

a) admixing an aqueous-based polymer composition and from 0.01 to 50 percent by weight of one or more hydroxy compounds selected from the group consisting of hydroxyalkyl ureas, hydroxyalkyl amides, and mixtures thereof, to form an aqueous-based polymer composition; and

b) b) applying said aqueous-based polymer composition to a substrate to maintain hydration of the substrate.

### DESCRIPTION OF THE INVENTION

This invention relates to a method for maintaining hydration of an aqueous-based polymer composition by admixing said aqueous-based polymer composition with a hydroxyalkyl urea or hydroxyalkyl amide.

Maintaining hydration, as used herein, means that the loss of hydration, either local or general, is slowed significantly, due to the presence in the aqueous polymer composition of either a hydroxyalkyl urea or hydroxyalkyl amide. In the general sense, loss of hydration relates to the loss of water from the polymer composition to the environment. In the localized sense, loss of hydration can mean the movement of water away from one part of the composition into a different part of the composition.

The hydroxy compound used in the invention is either a hydroxyalkyl urea, a hydroxyalkyl amide, or a mixture thereof. The hydroxyalkyl urea useful in the present invention is one containing one urea functionality and at least one hydroxyl functionality. The term urea, as used herein, refers to a N—CO—N moiety in which the other two bonds on each nitrogen atom form additional attachments, as for example those found in the illustrations and examples herein. The urea and hydroxyl functionalities may be separated from each other in the compound by one carbon atom. Preferably they are separated by at least two carbon atoms. The hydroxy amide useful in the invention is one containing at least one amide functionality and at least one hydroxyl functionality. Preferably the hydroxy compound should not be a formaldehyde emitter.

Preferred hydroxyalkyl urea compounds are derived from urea, and comprise only a single urea group, at least one hydroxyl group, and at least two carbon atoms disposed between the urea group and each of the hydroxyl groups. The two carbons disposed between the hydroxyl and urea groups may be in linear, branched or substituted configuration. The hydroxyalkyl urea compound is represented by structure (I) as follows:

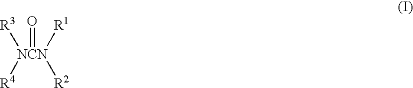

wherein

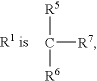

R² is H or R⁵, R³ is H or R⁵, and R⁴ is H, R¹, or R⁵, wherein

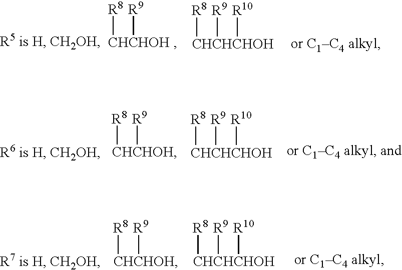

wherein R⁸ is H, methyl or ethyl, R⁹ is H, methyl or ethyl, and R¹⁰ is H, methyl or ethyl.

Preferred hydroxy urea compounds are N-2-hydroxyethyl urea, N,N-bis(2-hydroxyethyl)urea, tetrakis(2-hydroxyethyl)urea, tris(2-hydroxyethyl)urea, N,N′-bis(2-hydroxyethyl)urea, N,N′-bis(3-hydroxypropyl)urea, N,N′-bis(4-hydroxybutyl)urea, N-methyl-D-glucourea, and 2-urea-2-ethyl-1,3-propanediol. Most preferably, the hydroxy urea compounds are N,N′-bis(2-hydroxyethyl)urea and N-2-hydroxyethyl urea. Also, the hydroxy compounds may be generated by alkoxylating the compounds above. For example, the N-2-hydroxyethyl urea may be ethoxylated. Combinations of hydroxyalkyl urea compounds can also be used in the method of the invention.

The hydroxyalkyl urea compound is the reaction product of urea and an alkanolamine with the evolution of ammonia. Preferred alkanolamines include, but are not limited to, diethanolamine, monoethanolamine, 2-amino-2-methyl-1,3-propanediol, bis(hydroxymethyl)amino-methane, 2-methyl-3-amino-1-propanol and 2-methylaminoethanol. Processes for preparing the hydroxy urea compound is described in U.S. Pat. No. 5,858,549 which is incorporated herein by reference. (? Do you need both herby and herein; sounds strange)

Preferred hydroxyalkyl amide compounds are β-hydroxyalkyl amide compounds represented by structure (II) as follows:

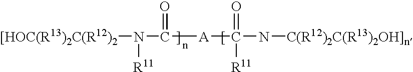

In structure (II), A is a bond, or a monovalent or polyvalent organic radical derived from a saturated or unsaturated alkyl radical wherein the alkyl radical contains from 1 to 60 carbon atoms, such as methyl, ethyl, propyl, butyl, pentyl, hexyl, heptyl, octyl, nonyl, decyl, eicosyl, triacontyl, tetracontyl, pentacontyl, hexylcontyl and the like; aryl, for example, mono- and dinuclear aryl such as phenyl, naphthyl and the like; alkylene amino such as trimethyleneamino, triethyleneamino and the like; or an unsaturated radical containing one or more ethylenic groups such as ethenyl, 1-methylethenyl, 3-butenyl-1,3-diyl, 2-propenyl-1,2-diyl, carboxy lower alkenyl, such as 3-carboxy-2-propenyl and the like, lower alkoxy carbonyl lower alkenyl such as 3-ethoxycarbonyl-2-propenyl and the like; R¹¹ is hydrogen, lower alkyl of from 1 to 5 carbon atoms such as methyl, ethyl, n-propyl, n-butyl, sec-butyl, tert-butyl, pentyl and the like or hydroxy lower alkyl of from 1 to 5 carbon atoms such as hydroxyethyl, 3-hydroxypropyl, 2-hydroxypropyl, 4-hydroxybutyl, 3-hydroxybutyl, 2-hydroxy-2-methylpropyl, 5-hydroxypentyl, 4-hydroxypentyl, 3-hydroxypentyl, 2-hydroxypentyl and the isomers of pentyl; R¹² and R¹³ are the same or different radicals selected from hydrogen, straight or branched chain lower alkyl of from 1 to 5 carbon atoms, or one of the R¹² and one of the R¹² and R¹³ radicals joined together with the carbon atoms to which they are attached to form a cycloalkyl, such as cyclopentyl, cyclohexyl and the like; n is an integer having a value of 1 or 2 and n′ is an integer having a value of 0 to 2 or when n′ is 0.

A preferred β-hydroxyalkyl amide compound is represented by structure (III) as follows:

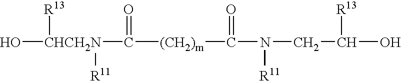

In structure (III), R¹¹ is H, lower alkyl, or HOC(R¹³ )₂C(R¹²)₂, n and n′ are each 1,-A- is —(CH₂)[m]-, m is 0 to 8 preferably 2 to 8, each R¹² is H, and one of the R¹³ radicals in each case is H and the other is H or a C₁-C₅ alkyl; that is wherein R¹¹, R¹³, and m have the meanings just given. The most preferred β-hydroxyalkyl amide compound is represented by structure (IV) as follows:

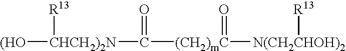

In structure (IV), R¹³ is H or —CH₃.

Specific examples of β-hydroxyalkyl amide compounds are bis[N,N-di(beta-hydroxyethyl)]adipamide, bis[N,N-di(beta-hydroxypropyl)]succinamide, bis[N,N-di(beta-hydroxyethyl)]azelamide, bis[N-N-di(beta-hydroxypropyl)]adipamide, and bis[N-methyl-N-(beta-hydroxyethyl)]oxamide.

The β-hydroxyalkyl amide compounds are either known compounds or may be prepared by treating an ester with an amine at a temperature in the range of from about ambient to about 200° C. Suitable esters are prepared by esterifying the corresponding acid by standard esterifying procedures. Among the preferred acids used to prepare the β-hydroxyalkyl amide crosslinking agents are oxalic, malonic, succinic, glutaric, adipic, pimelic, suberic, azelaic, sebacic, 1,4-cyclohexane and the like and alkyl derivatives thereof. Dimer and trimer acids may also be used. Suitable amines used to prepare the β-hydroxyalkyl amide compounds are 2-aminoethanol; 2-methylaminoethanol; 2-ethylaminoethanol; 2-n-propylaminoethanol; 2,2′-iminodiethanol; 2-aminopropanol; 2,2′-iminodiisopropanol; 2-aminocyclohexanol; 2-aminocyclopentanol; 2-aminomethyl-2-methylethanol; 2-n-butylaminoethanol; 2-methylamino-1,2-dimethylethanol; 2-amino-2-methyl-1-propanol; 2-amino-2-methyl-1,3-propanediol; 2-amino-2-ethyl-1,3-propanediol and 2-amino-2-hydroxymethyl-1,3-propanediol. The β-hydroxyalkyl amide compounds are prepared according to processes described in U.S. Pat. No. 4,076,917 which is hereby incorporated herein by reference.

The aqueous-based polymer composition is a stable composition containing one or more polymers and water. The composition could be in the form of an emulsion, dispersion, suspension, or solution. The polymers are not limited by chemistry, molecular weight, particle size, or polymer architecture. They may be homopolymers, or copolymers having two or more monomers. The copolymers may be random, block, tapered, star, or of other known architecture. Both natural and synthetic polymers may be used in the invention. Stability may be achieved through the use of surfactants, colloids, and other stabilizers known in the art.

In one embodiment, the polymer composition is an emulsion polymer formed by emulsion polymerization of one or more ethylenically unsaturated monomers. The emulsion latex may be formed in a batch process, a semi-batch process, or a continuous process. The emulsion can be stabilized by surfactants, colloids, or a combination thereof. One skilled in the art will recognize that different monomers, and percentages of said monomers, can be optimized to obtain the end-use properties desired in the polymer. Useful monomers include, but are not limited to, (meth)acrylates, maleates, (meth)acrylamides, itaconates, styrenics, acrylonitrile, nitrogen functional monomers, vinyl esters, alcohol functional monomers, butadiene and other unsaturated hydrocarbons, vinyl acetate, vinyl chloride, and phenoxy ethyl acrylates.

Low levels of crosslinking monomers may also be used to form the polymer, though crosslinking generally increases incompatibility and therefore will not be present in any great amount. Chain-transfer agent may also be used, as known in the art, in order to regulate chain length and molecular weight. The chain transfer agents may be multifunctional so as to produce star type polymers.

Solutions of water-soluble polymers may also be hydration stabilized by the method of the invention. Examples of these include, but are not limited to high molecular weight polyacrylic acid solutions, polyacrylamide solutions, inverse solution polymers of acrylamide, and polyvinyl alcohol solutions.

Aqueous polymer dispersions are stable dispersions of natural and/or synthetic polymers in water. In one embodiment, the dispersion is a stable dispersion of a natural polymer. The natural polymer may advantageously be a starch or a modified starch; gum; cellulosic and modified cellulosic such as hydroxy propyl methyl cellulose, or hydroxy methyl cellulose; and waxes such as parrafin. A liquid cationic starch dispersion that is stable in the liquid state is one preferred embodiment of the invention. Polymeric emulsions used in consumer compositions, including, but not limited to dimethiconol polymer emulsions, and silicone emulsions, would also be included in the invention.

Aqueous-based polymer compositions include also mixed solvent systems of water with water-miscible solvents such as low molecular weight alcohols.

The polymer composition may be formulated with one or more adjuvants that are useful in end-use applications of the polymer composition. Such adjuvants include, but are not limited to, suspension aids, thickening agents, parting agents, penetrating agents, wetting agents, thermal gelling agents, sizing agents, defoaming agents, foam suppressors, blowing agents, coloring agents, oxidation inhibitors, quenchers, antiseptic agents, dispersants, antistatic agents, crosslinking agents, dispersants, lubricants, plasticizers, pH regulators, flow modifiers, setting promoters, fillers, water-proofing agents, medications, fragrances, detergents, anti-bacterial or anti-fouling agents, surfactants and mixtures thereof. Adjuvants may be present in the polymer composition at from 0 to 10,000 (10 or 10000?) parts based on 100 parts of polymer. In compositions that are gels, creams or lotions, a rheology modifier would be present. The rheology modifier could be a synthetic polymer, such as an acid or base thickening polymer, silicones, dimethecone; or it could be a natural polymer such as a starch, modified starch, xanthan, guar gum, or cellulose and modified celluloses.

The aqueous-based polymer composition is combined with from 0.01 to 50 percent by weight, and preferably from 1 to 10 percent by weight of the hydroxy alkyl urea or hydroxyalkyl amide at, based on the weight of hydroxy alkyl urea or hydroxyalkyl amide to polymer solids.

The aqueous-based polymer composition and hydroxy alkyl urea or hydroxyalkyl amide are admixed and agitated until a homogeneous solution is formed in the water phase, to form a polymer formulation. The hydroxy alkyl urea or hydroxyalkyl amide could also be added during the polymerization, or once the polymerization has been completed. Generally the hydroxy compound is post-added to the polymer composition. An aqueous based polymer formulation containing the hydroxy alkyl urea or hydroxyalkyl amide and polymer composition may be in the form of a polymer solution, a polymer emulsion, a polymer dispersion, a gel, a cream, or a lotion. The addition of the hydroxy compound to the polymer composition aids in maintaining hydration of the polymer composition.

The method of the present invention is useful in maintaining hydration of an aqueous-based polymer composition. There are many examples of how hydration maintenance using the method of the present invention may contribute to the effectiveness of the polymer composition. The applications listed below are illustrative of some important uses for this invention. One of skill in the art can imagine many similar uses.

In one embodiment, the hydration retention leads to freeze-thaw stability of the aqueous-based polymer composition. When water molecules crystallize, everything else tends to be excluded from the ordered structure, including stabilized, dispersed, or dissolved polymer particles. The polymer particles dehydrate and come in contact with each other, allowing them to stick together, agglomerate, or coalesce. These changes are irreversible and the agglomerated polymer particles will not redisperse upon thawing, making the product useless. In polymer solutions, the polymer chains can also agglomerate, reducing end-use properties. The addition of small amounts of hydroxyalkyl urea or hydroxy alkyl amide to the polymer composition can prevent the localized loss of water and destabilization caused by the freeze/thaw conditions. This application is especially applicable to emulsions and dispersions.

In another embodiment the addition of small amounts of hydroxyalkyl urea or hydroxy alkyl amide to a polymer composition can prevent the loss of water in end-use applications, and in storage of partially-used materials. The loss of water from a polymer composition can lead to higher-viscosity, which may hinder the application of the product in an industrial setting. Water loss could also concentrate the polymer composition, possibly leading to pre-mature cross-linking and other reactions. Loss of water leads to a more concentrated composition, which may be less stable due to higher packing of the particles, creating a higher probability for flocculation or coagulation. In this embodiment, the hydroxy compound would preferably be used at a level of from 0.5 to 10 percent by weight, based on the weight of the polymer solids.

In still another embodiment, the polymer composition may be formulated with hydroxyalkyl urea and/or hydroxyalkyl amides plus adjuvants and/or active ingredients, including the adjuvants listed above and preferably pesticides, fragrances, anti-bacterials, pharmaceuticals, fungicides, insecticides, and herbicides. The adjuvants are present at from 0.1 to 75 percent, based on total weight of the aqueous composition. The formulation is then applied to a substrate. Application to a substrate may occur by known means such as saturation and spray. The polymer composition may reside primarily on the substrate surface, or may saturate the substrate. The substrate is then sold as a pre-wetted article. Substrates that may contain the aqueous polymer composition include, but are not limited to, non-wovens, synthetic materials, and fabrics. The substrates may be formed into pre-wetted wipes, mop heads, towels, toilet paper, sponges, or other articles. One preferred embodiment is a pre-moistened disposable non-woven wipe. Pre-moistened wipes have many uses, including but not limited to skin cleaning, disinfectant wipes, baby wipes, car wipes, and hard-surface cleaners. Once the container holding the wipes is opened, it may not be re-sealed completely, leading to drying of the substrate. Once the wipes dry out, they are not effective as intended. The addition of small amounts of hydroxyalkyl urea or hydroxy alkyl amide to the polymer composition can retard the loss of water from the moist wipes. Useful amounts of the hydroxy compound would be from 0.001 to 10 percent by weight, and preferably from 0.1 to 3 percent by weight, based on the weight of the substrate.

Substrates containing the polymer composition of the invention may also be used to transfer the hydroxyalkyl urea or hydroxy alkyl amide to another substrate, and that second substrate could benefit from the hydration maintenance discussed above. Such substrates could include skin and hair such as in the application of a gel, cream, or lotion containing said aqueous polymer formulation of the invention to the skin or hair. Also, application to skin or hair may occur from a pre-wetted wipe as described above. Additionally the substrates containing the hydroxy compound could be applied to eyes in solution for ? or contact lenses, in mouthwash and toothpastes for teeth, for moisturising leather and suede, and moisture retention in paper coatings.

One of skill in the art could imagine many similar uses for the compositions of the present invention. Some other uses would include, but not be limited to: application to metals such as for deicing of airplanes and metal working fluids; seed coating freeze thaw stability, the prevention of the freezing of plants during frost condition either by uptake of HAU into plant leaves or through prevention of root freezing; freeze thaw stability for any aqueous dispersion including aqueous paints and coating formulations, drug and pesticide formulations, oil in water emulsions, suspension of a non-water-miscible material in water.

When used as a seed coating, it was noticed that an increased germination speed and percentage occurred in seeds coated with a pesticide formulation that contained the hydroxy compound—versus the same pesticide formulation without the hydroxy compound. While not being bound by any theory, it is believed that this observation could be related to a fertilizer effect due to the extra nitrogen available. The sprouts were very dark, healthy green instead of yellow-green.

The following non-limiting examples illustrate further aspects of the invention.

### EXAMPLE 1

106.2 g diethanolamine and 61.24 g urea were charged to a 250 mL flask equipped with a condenser, thermometer, stirrer, and nitrogen purge needle. The mixture was heated at 115° C. for 5 hours. A nitrogen purge was used to remove evolving ammonia. The progress of the reaction was monitored by titration of the remaining diethanolamine with 0.1 N hydrochloric acid. A clear hydroscopic liquid was obtained which contained N,N-bis(2-hydroxyethyl)urea.

### EXAMPLES 2-7

The following amines were reacted with urea according to the procedure set forth in Example 1.

TABLE 1

| Example | Amine | Wt, g | Urea g |
|---|---|---|---|
| 2 | Ethanolamine | 61 | 60 |
| 3 | 3-amino-1-propanol | 150 | 60 |
| 4 | 2-amino-2-ethyl-1,3-propanediol | 119 | 30 |
| | (AEPD) | | |
| | Ethanolamine | 122 | 60 |
| 6 | Diethanolamine | 210 | 60 |
| 7 | 4-aminobutanol | 12 | 4 |

### EXAMPLE 8

212.4 g diethanolamine in 212.4 g of water was neutralized with 101.85 g concentrated sulfuric acid to a pH of 4. A solution of 168.99 g potassium cyanate in 260 g of water was then added and the mixture was heated to 90° C. for 3 hours. After cooling to ambient temperature, potassium sulfate precipitated and was filtered out. The filter cake was washed with 425 g of hot ethanol. The recovered ethanol was then added to the contents of the filtrate, causing the filtrate to become cloudy. The white precipitate was removed by filtration and then the ethanol was removed by distillation to give a viscous liquid solution of N,N-bis(2-hydroxyethyl)urea. The product similarly could be obtained using other acids to neutralize the amine, e.g. sulfuric acid. Also, other cyanate salts could be used, e.g. sodium cyanate.

### EXAMPLE 9

Following the procedure of Example 8, 195.22 g N-methyl-D-glucamine in 200 g water were reacted with 98.08 9 sulfuric acid. After adjusting pH to 4, 81.11 g potassium cyanate was charged to the flask in 100 g water. The mixture was heated to 70° C. for 2 hours. After cooling to 0° C., the precipitated potassium sulfate byproduct was removed by filtration. The filtrate was treated with 250 mL of hot methanol and again filtered to remove any remaining salt byproduct. The methanol was then removed by vacuum distillation to give a solution containing N-methyl-D-glucourea.

### EXAMPLE 10

Using the procedure set forth in Example 1, the reaction can also be conducted effectively using refluxing water as a means of removing evolving ammonia. 105 g diethanolamine, 25 g water, and 60 g urea were charged in a 250 mL flask equipped with heating mantle, stirrer, and thermometer and allowed to react at 115° C. for 8 hours.

### EXAMPLE 11

210 g diethanolamine and 90 g dimethylcarbonate were charged to a flask with a heating mantle, stirrer, and condenser. The flask contents were heated to 80° C. and allowed to stir for 3 hours. Volatile byproducts, e.g., methanol, were removed by vacuum distillation. A mixture containing tetrakis(2-hydroxyethyl)urea was obtained.

### EXAMPLE 12

To a solution of 106 g of diethanolamine in 700 mL of methanol was added a solution of 99 g of n-butylisocyanate in 40 mL of tetrahydrofuran over 1 hour, holding the temperature below 30° C. After the addition, the mixture was stirred for 1 hour and then the solvent was removed by vacuum distillation to give a white solid, N′-butyl-N,N-bis(2-hydroxyethyl)urea.

### EXAMPLES 13-14

The following amines were reacted with an isocyanate according to the procedure set forth in Example 12.

TABLE 2

| | | Wt. | | Wt. |
|---|---|---|---|---|
| Example | Amine | (g) | Isocyanate | (g) |
| 13 | Ethanolamine | 61 | N-butyl isocyanate | 99 |
| 14 | N-methyl-D-glucoamine | 196 | N-butyl isocyanate | 99 |

### EXAMPLE 15

A 500 mL flask equipped with stirrer and condenser was charged with 145.1 g of 40% glyoxal and 90 g of urea. The temperature was held at 30° C. for 6 hours. The resultant solution contained 4,5-dihydroxyimidazolidone.

### EXAMPLE 16: (COMPARATIVE)

A 15 gram sample of an ethylene/vinyl acetate emulsion stablized with polyvinyl alcohol was frozen for 24 hours in a freezer which has a temperature ranging from −8 to −20° C. The sample was thawed at room temperature. The particles were aggregated and phase separated and could not be redispersed. The sample did not flow.

### EXAMPLE 17

A 15 gram sample of the emulsion of Example 16 was blended with 0.75 grams (5% by total weight) of bis(2 hydroxyethyl)urea. The sample was frozen, then thawed at room temperature. There were no visible signs of aggregation, and the sample flowed from a pipette.

### EXAMPLE 18: (COMPARATIVE)

A 15 sample of an ethylene/vinyl acetate/butyl acetate emulsion that was surfactant stabilized was frozen for 24 hours, thawed at room temperature, refrozen for 16 hours, and thawed again at room temperature. The freezer had a temperature ranging from −8 to −20° C. The emulsion was thick and agglomerated and did not flow.

### EXAMPLE 19

A 15 gram sample of the emulsion of Example 18 was blended with 0.75 grams (5% by total weight) of solid bis(2 hydroxyethyle)urea. The sample was frozen, then thawed at room temperature. There were no visible signs of aggregation, and the sample flowed from a pipette.

### EXAMPLE 20

A 15 gram sample of the emulsion of Example 16 was blended with 0.3 grams (2% by total weight) of mono(2 hydroxyethyl)urea. The sample was frozen for 21 hours at a temperature in the range of −8 to −20° C. The sample was thawed at room temperature. No visible signs of aggregation were seen.

### EXAMPLE 21

Example 20 was repeated using 0.3 grams of solid bis(2hydroxyethyl)urea. No visible signs of aggregation were seen in the thawed sample.

### EXAMPLE 22

Example 20 was repeated using the emulsion of example 18 blended with 5% by weight of mono(2 hydroxyethyl)urea. No visible signs of aggregation were seen.

### EXAMPLE 23: (COMPARATIVE)

Example 22 was repeated using the emulsion of example 18 without any hydroxyalkyl urea added. The thawed emulsion was irreversibly flocculated.

### EXAMPLE 24

A sample of the emulsion of example 18 was blended with 5% by weight of N-methyl-D-glucourea was frozen for 17 hours at a temperature in the range of −8 to −20° C. No visible signs of aggregation were seen.

### EXAMPLE 25

Example 24 was repeated using the emulsion of example 16 with 5% N-methyl-D-glucourea. No visible signs of aggregation were seen.

### EXAMPLE 26

a) A 15 gram sample of a surfactant stabilized vinyl acetate/butyl acetate emulsion was tested without any hydroxy alkyl urea added.

b) The emulsion of (a) was blended with 10% by weight of bis(2hydroxyethyl)urea.

c) The emulsion of (a) was blended with 5% by weight of mono(2 hydroxyethyl)urea

d) The emulsion of (a) was blended with 10% by weight of mono(2 hydroxyethyl)urea

The samples were frozen for 17 hours then thawed at room temperature for 7 hours, and the cycle repeated.

Sample (a) aggregated after one freeze/thaw cycle.

Samples (b), (c), and (d) showed no sign of aggregation after 5 freeze/thaw cycles.

### EXAMPLE 27

A paint formulation based on the same surfactant stabilized vinyl acetate/butyl acetate emulsion as in Example 26 was formulated with 10% by weight of mono(2 hydroxyethyl)urea, and half the quantity of propylene glycol normally required for freeze-thaw stability. The formulation was subjected to 4 freeze/thaw cycles as in Example 26, with no sign of aggregation.

### EXAMPLE 28

Personal care formulations would be formulated in the folowing manner to take advantage of the method of the present invention:

| | |
|---|---|
| Ingredients | WT % |

Shampoo formulation:

| | |
|---|---|
| Lauryl ether sulfate 2 EO | 16 |
| Cocamidopropyl betaine | 2 |
| Dimethiconol polymer emulsion (60%) | 3.2 |
| Ethylene glycol distearate | 1.5 |
| N,N bis hydroxyethyl urea | 2 |
| Water | rest |

Conditioner

| | |
|---|---|
| Cetyltrimethylammonium chloride | 1 |
| Stearyl alcohol | 3 |
| Paraffin | 1 |
| Hydroxy propylmethyl cellulose | 1.5 |
| N,2 hydroxy ethyl urea | 1 |
| Water | rest |

Shower gel

| | |
|---|---|
| Myristic acid | 5 |
| Lauric acid | 5 |
| Oleic acid | 5 |
| N-methyl-D-glucourea | 3 |
| Cocoamidopropyl betaine | 10 |
| Silicone emulsion (60%) | 2 |
| 50% NaOH | 7 |
| Water | rest |

What is claimed is:

1. A method for maintaining hydration of an aqueous-based polymer composition comprising admixing said aqueous-based polymer composition and from 0.01 to 50 percent by weight of one or more hydroxy compounds selected from the group consisting of hydroxyalkyl ureas, hydroxyalkyl amides, and mixtures thereof.

2. The method of claim 1 wherein said aqueous-based polymer composition comprises admixing from 1 to 10 percent by weight of one or more hydroxy compounds.

3. The method of claim 1 wherein said hydroxy compound comprises a (hydroxyalkyl)urea, β-hydroxyalkylamide, or combinations thereof.

4. The method of claim 3 wherein
a) said (hydroxyalkyl)urea has the structure 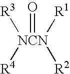
wherein 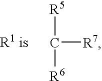
R² is H or R⁵, R³ is H or R⁵, and R⁴ is H, R¹, or R⁵, wherein 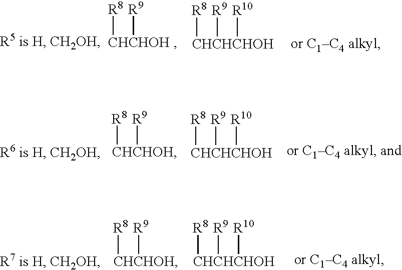
wherein R⁸ is H, methyl or ethyl, R⁹ is H, methyl or ethyl, and R¹⁰ is H, methyl or ethyl; and
b) said β-hydroxyalkylamide has the structure 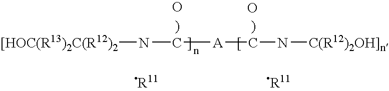
wherein A is a bond, a monovalent or polyvalent organic radical derived from a saturated or unsaturated alkyl containing from 1 to 60 carbon atoms, aryl, tri-lower alkyleneamino or an ethylenically unsaturated radical; R¹¹ is selected from the group consisting of hydrogen, lower alkyl having 1 to 5 carbon atoms, and hydroxyalkyl having from 1 to 5 carbon atoms; R¹² and R¹³ are independently selected from the group consisting of hydrogen, straight or branched chain lower alkyl having from 1 to 5 carbon atoms, and one of the R¹² and R¹³ radicals joined together with the carbon atoms to which they are attached to form a cycloalkyl; n is an integer of 1 or 2 and n′ is an integer of 0 to 2; n being 2 when n′ is 0.

5. The method of claim 2 wherein said hydroxy compound is selected from the group consisting of N,N-bis(2-hydroxyethyl)urea, tetrakis(2-hydroxyethyl)urea, tris(2-hydroxyethyl)urea, N,N′-bis(2-hydroxyethyl)urea, N,N′-bis(3-hydroxypropyl)urea, N,N′-bis(4-hydroxybutyl)urea, 2-urea-2-ethyl-1,3-propanediol, N-hydroxyethylurea, N-methyl-D-glocourea, and combinations thereof.

6. The method according to claim 2 wherein said β-hydroxyalkylamide is selected from the group consisting of bis[N,N-di(beta-hydroxyethyl)]adipamide, bis[N,N-di(beta-hydroxypropyl)]succinamide, N-2-hydroxyethylurea, bis[N,N-di(beta-hydroxyethyl)]azelamide, bis[N-N-di(beta-hydroxypropyl)]adipamide, and bis[N-methyl-N-(beta-hydroxyethyl)]oxamide.

7. The method of claim 1 wherein said aqueous polymer composition comprises an emulsion polymer.

8. The method of claim 1 wherein said aqueous polymer composition comprises a solution polymer.

9. The method of claim 1 wherein said aqueous polymer composition comprises a polymer dispersion.

10. The method of claim 9, wherein said polymer dispersion comprises a natural or synthetic polymer.

11. The method of claim 10, wherein said natural polymer is a starch or modified starch.

12. The method of claim 1 wherein said aqueous-based polymer composition comprises a gel, a cream, or a lotion.

13. A method of maintaining hydration of a substrate comprising:
a) admixing an aqueous-based polymer composition and from 1 to 10 percent by weight of one or more hydroxy compounds selected from the group consisting of hydroxyalkyl ureas, hydroxyalkyl amides, and mixtures thereof, to form an aqueous-based polymer formulation;
b) applying said aqueous-based polymer composition to a substrate to maintain hydration of the substrate.

14. The method of claim 13, wherein said substrate is selected from the group consisting of a non-woven, a fabric, a sponge, a towel, a mop head, skin or hair.

15. The method of claim 13, wherein said polymer formulation further comprises from 0.1 to 75 percent by weight of one or more adjuvants, based on total weight of the aqueous composition.
